(19) United States
(12) Patent Application Publication
(10) Pub. No.: US 2012/0213197 A1
(43) Pub. Date: Aug. 23, 2012

(54) Methods and Apparatuses for Managing Multiple Call Sessions During a Transfer

(75) Inventors: Marko Tapani Niemi, Oulu (FI); Mika Ilmari Leppänen, Oulu (FI)

(73) Assignee: Renesas Mobile Corporation

(21) Appl. No.: 13/031,440

(22) Filed: Feb. 21, 2011

(51) Int. Cl. H04W 36/00

(52) U.S. Cl. 370/331

(57) ABSTRACT

Various methods for managing multiple call sessions during a transfer are provided. One example method may include detecting an initiation of a handover of a wireless device from a connection to a packet switched domain to a connection to a circuit switched domain. The wireless device may be a party to more than one call session. The example method may further include receiving a multiple call session indicator that provides an indication that the wireless device is party to multiple call sessions, and in response to receiving the multiple call session indicator, creating or updating call control state machines for each of the call sessions. Similar and related example methods, example apparatuses, and example computer program products are also provided.

### TECHNICAL FIELD

Various embodiments relate generally to wireless communications, and, more particularly, relate to a method, apparatus, and computer program product for managing multiple call sessions during a transfer.

### BACKGROUND

Communications technology continues to evolve, particularly in the area of wireless communications. While some evolutionary changes are relatively small, others can introduce entirely new platforms that involve the installation of different network infrastructure and new software. Since the construction of network infrastructure can be very costly, companies are not always able to quickly transition their entire network from older platforms to newer platforms. As such, there is often a transition period where devices must be configured to operate on both new and legacy platforms. Not only do challenges arise from the need to develop devices that can operate on both platforms, but increasingly complex challenges can arise due to the need for graceful transitions of communications sessions between the different types of platforms without negatively impacting user experience.

### SUMMARY

Example methods and apparatuses are described herein that provide for managing multiple call sessions during a transfer. One example method may include detecting an initiation of a handover of a wireless device from a connection to a packet switched domain to a connection to a circuit switched domain. In this regard, the wireless device may be a party to more than one call session. The example method may further include receiving a multiple call session indicator, where the multiple call session indicator provides an indication that the wireless device is party to multiple call sessions. The example method may also include creating or updating call control state machines for each of the call sessions, in response to receiving the multiple call session indicator.

Another example embodiment is an example apparatus that comprises specifically configured processing circuitry. In this regard, the processing circuitry may be configured to detect an initiation of a handover of a wireless device from a connection to a packet switched domain to a connection to a circuit switched domain. In this regard, the wireless device may be a party to more than one call session. The processing circuitry may be further configured to receive a multiple call session indicator, where the multiple call session indicator provides an indication that the wireless device is party to multiple call sessions. The processing circuitry may also be configured to create or update call control state machines for each of the call sessions, in response to receiving the multiple call session indicator.

Yet another example embodiment is an apparatus or article of manufacture in the form of a non-transitory computer readable medium having program code stored thereon. The program code, when executed by an apparatus, may configure processing circuitry to perform various functionalities. In this regard, the program code may configure the processing circuitry to detect an initiation of a handover of a wireless device from a connection to a packet switched domain to a connection to a circuit switched domain. The wireless device may be a party to more than one call session. The program code may further configure the processing circuitry to receive a multiple call session indicator, where the multiple call session indicator provides an indication that the wireless device is party to multiple call sessions. Additionally, the program code may configure the processing circuitry to create or update call control state machines for each of the call sessions, in response to receiving the multiple call session indicator.

Another example apparatus may include means for detecting an initiation of a handover of a wireless device from a connection to a packet switched domain to a connection to a circuit switched domain. In this regard, the wireless device may be a party to more than one call session. The example apparatus may further include means for receiving a multiple call session indicator, where the multiple call session indicator provides an indication that the wireless device is party to multiple call sessions. The example apparatus may also include means for creating or updating call control state machines for each of the call sessions, in response to receiving the multiple call session indicator.

Yet another example method may include determining that a wireless device, that is implementing a handover from a packet switched domain to a circuit switched domain, is a party to more than one call session including a first call session and a second call session. The example method may further include causing a multiple call session indicator to be sent from a network entity to the wireless device, where the multiple call session indicator provides an indication that the wireless device is party to multiple call sessions.

Another example embodiment is an example apparatus that comprises specifically configured processing circuitry. In this regard, the processing circuitry may be configured to determine that a wireless device, that is implementing a handover from a packet switched domain to a circuit switched domain, is a party to more than one call session including a first call session and a second call session. The processing circuitry may be further configured to cause a multiple call session indicator to be sent from a network entity to the wireless device, where the multiple call session indicator provides an indication that the wireless device is party to multiple call sessions.

Yet another example embodiment is an apparatus or article of manufacture in the form of a non-transitory computer readable medium having program code stored thereon. The program code, when executed by an apparatus, may configure processing circuitry to perform various functionalities. In this regard, the program code may configure the processing circuitry to determine that a wireless device, that is implementing a handover from a packet switched domain to a circuit switched domain, is a party to more than one call session including a first call session and a second call session. The program code may further configure the processing circuitry to cause a multiple call session indicator to be sent from a network entity to the wireless device, where the multiple call session indicator provides an indication that the wireless device is party to multiple call sessions.

Another example apparatus may include means for determining that a wireless device, that is implementing a handover from a packet switched domain to a circuit switched domain, is a party to more than one call session including a first call session and a second call session. The example apparatus may further include means for causing a multiple call session indicator to be sent from a network entity to the wireless device, where the multiple call session indicator provides an indication that the wireless device is party to multiple call sessions.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example system and connections involved in a handover of a wireless device from a packet switched domain to a circuit switched domain according to some example embodiments;

FIG. 2 illustrates a block diagram of a wireless communications apparatus and associated system configured to manage multiple call sessions during a transfer according to some example embodiments;

FIG. 3 illustrates an example flowchart for managing multiple call sessions during a transfer according to some example embodiments;

FIG. 4 illustrates a block diagram of a network apparatus and associated system configured to manage multiple call sessions during a transfer according to some example embodiments;

FIG. 5 illustrates another example flowchart for managing multiple call sessions during a transfer according to some example embodiments; and

FIG. 6 illustrates a number of alternative signaling schemes for providing a multiple call session indicator according to various example embodiments.

### DETAILED DESCRIPTION

Example embodiments will now be described more fully hereinafter with reference to the accompanying drawings, in which some, but not all embodiments are shown. Indeed, embodiments may take many different forms and should not be construed as limited to those set forth herein. Like reference numerals refer to like elements throughout. As used herein, the term ‘circuitry’ refers to components that include at least one electronic hardware device that is either statically configured via a manufacturing or initialization process to perform particular functionality, dynamically configurable through the execution of program code instructions to perform particular functionality, or a combination thereof.

Example methods and example apparatuses are provided herein that facilitate the implementation of a transfer or handover of a wireless device from a connection with a packet switched domain to a connection with a circuit switched domain. Handovers of this type may be required, for example, when a wireless device physically moves out of an environment that is being served by a packet switched domain and into an environment that is served by a circuit switched domain. The handover may impact ongoing sessions, such as call sessions between the user of the wireless device and remote parties. Some wireless devices may be configured to perform this type of handover using a single radio. As such, in a cellular communications environment, the handover may be part of a single radio voice call continuity (SRVCC) process.

In some instances, a wireless device may be currently participating in multiple call sessions when the handover occurs. As used herein, multiple call sessions refers to either (a) an active call session and a held call session or (b) an active call session and one or more additional conference call sessions with parties to a conference call. In this regard, for example, a wireless device may be actively involved in a first voice call session, while another voice call session for the wireless device is kept on hold. The call session that is on hold may be handled by a network entity, and, in some example embodiments, the wireless device may play no role in the handling of the call session that is on hold. In this regard, if the wireless device was to end the active voice call session, the network entity that is handling the call session that is on hold may ring the wireless device to notify the wireless device of the call session that is on hold and transition the session to an active call session.

Since the wireless device may not be aware that a call is on hold, issues can arise where the call session that is currently on hold is not properly transitioned from the packet switched domain to the circuit switched domain during the handover. Similar issues can arise when a wireless device is party to a conference call during the handover, which can involve multiple call sessions with multiple remote parties. As a mechanism to avoid failed or improperly completed transfers of call sessions during a handover, according to various example embodiments, a network entity may be configured to provide a multiple call session indicator to the wireless device, to thereby inform the wireless device that multiple call sessions for the wireless device are ongoing. In this regard, for example, a network entity of the packet switched domain may provide the multiple call session indicator to the wireless device, or the network entity of the packet switched domain may provide the multiple call session indicator to a network entity of the circuit switched domain which in turn may provide the multiple call session indicator to the wireless device. In response to receiving the multiple call session indicator, the wireless device may be configured to take action with respect to, not only an active call session, but also with respect to a call session that is on hold, or with respect to call sessions associated with a conference call to facilitate a proper handover of the call sessions to the circuit switched domain.

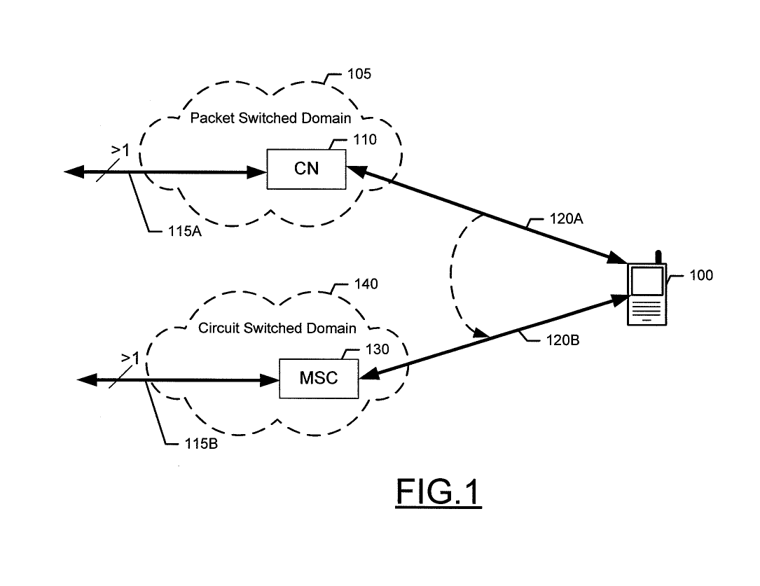

FIG. 1 illustrates a system implementing a handover of a wireless device 100 from a packet switched domain 105 to a circuit switched domain 140, in accordance with various example embodiments. The system of FIG. 1 includes a core network (CN) entity 110 of the packet switched domain 105, a mobile switching center (MSC) 130 of the circuit switched domain 140, and a wireless device 100. The core network entity 110 may be a communications and computing device configured to support a connection with the wireless device 100 in the packet switched domain 105. The mobile switching center 130 may also be a communications and computing device. However, the mobile switching center 130 may be configured to support a connection with the wireless device 100 in the circuit switched domain 105. The wireless device 100 may be any type of wireless communications device configured to communicate in either a packet switched or circuit switched domain.

According to FIG. 1, multiple calls sessions 115A may be initially handled by the packet switched domain 105 for the wireless device 100. In this regard, a network entity of the packet switched domain may be configured to maintain the multiple call sessions for the wireless device 100 and facilitate connecting the wireless device 100 to one or more of the call sessions 115A via a connection 120A to the wireless device 100. The network entity responsible for maintaining the call sessions 115A may be a CN entity 110 of the packet switched domain. For example, the core network entity 110 may be configured to permit an active call session to be delivered to the wireless device 100, while maintaining another call session in an “on hold” status for the wireless device, which need not be delivered to the wireless device. Similarly, the core network entity 110 may be configured to maintain call sessions associated with a conference call, where the wireless device is a participant in the conference call via the connection 120A.

Subsequently, the wireless device may need to perform a handover from the connection with the packet switched domain to a connection with a circuit switched domain. According to various example embodiments, the handover may be part of a mid-call single radio voice call continuity (SRVCC) handover. The handover may need to be performed because, for example, the wireless device may be physically moving from an environment that is served by the packet switched domain 105 to an environment served by the circuit switched domain 140 and the MSC 130. The wireless device 100 may therefore be configured to detect that the device is moving out of the signaling range of the packet switched domain, and into the signaling range of the circuit switched domain. In some example embodiments, detection of the handover may occur as a result of receiving an SRVCC handover message from a network entity (e.g., the mobile switching center 130). As a result of the handover procedure, the wireless device 100 may be transferred to a connection 120B between the mobile switching center 130 and the wireless device 100 in the circuit switched domain 140. The mobile switching center 130 may maintain the sessions with the wireless device 100 as call sessions 115B. As such, multiple call sessions may be transferred from the packet switched domain to the circuit switched domain.

According to various example embodiments, prior to or after initiating the handover, a network entity of the packet switched domain 105 that is serving the wireless device 100 may send a notification to the wireless device 100 indicating that the wireless device 100 is party to more than one call session that is being handled in the network. Alternatively, the network entity of the packet switched domain may provide the notification to, for example, the MSC 130, and the MSC 130 may notify the wireless device that the wireless device is party to multiple call sessions. The notification may be provided in the form of a multiple call session indicator, which, according to various example embodiments, may be included in, for example, a call control protocol message, a radio control message, a single radio voice call continuity handover (SRVCC HO) message, or the like. Further, sending the multiple call session indicator may be defined in a non-access stratum (NAS) level procedure. However, in some example embodiments, the multiple call session indicator may be provided in a communication that is not provided in the NAS call control layer, but possibly in another NAS layer.

According to some example embodiments, the CN entity 110 or the MSC 130 may be configured to provide the multiple call session indicator, without having been triggered by the wireless device to do so. In this regard, for example, the MSC 130 may provide the multiple call session indicator repeatedly based on some time interval, at a scheduled time, in response to some trigger (i.e., receipt of a notification from the CN entity 110), or the like. Further, the multiple call session indicator may be provided in a ‘progress’ message that has the description, “held call in network.” The wireless device 100 may trigger, for example, the MSC 130 to provide the multiple call session indicator to the wireless device. In this regard, according to some example embodiments, the MSC 130 may be triggered to provide the multiple call session indicator to the wireless device 100 in response to a message received from the wireless device 100, where the message is a ‘status enquiry’, other type of request, or the like. According to some example embodiments, the CN entity 110 may be triggered by the wireless device to provide the multiple call session indicator to the MSC 130, which may, in turn, provide the indicator to the wireless device 100.

In response to receiving the multiple call session indicator and detecting that the wireless device is transitioning from a packet switched domain to a circuit switched domain, the wireless device 100 may complete the handover in a manner that accommodates the transfer of the multiple call sessions. In this regard, the wireless device may create or update call control state machines for the multiple call sessions. According to some example embodiments, the multiple call session indicator may include a value indicating the number of open call sessions for the wireless device 100. Additionally or alternatively, the multiple call session indicator may include one or more transaction identifiers respectively assigned to the call sessions. Further, the wireless device 100 may be configured to assign transaction identifiers to each of the call sessions and provide the transaction indicators to the mobile switching center 130 of the circuit switched domain to facilitate the handover. In this regard, an active call session may be provided a transaction identifier of, for example, ‘000’, and a call session that is on hold may be provided a transaction identifier of ‘001’. For a conference call, each participant and associated call session may be assigned a transaction identifier and the transaction identifiers may be provided to the wireless device 100, possibility with call control statuses. The mobile switching center 130 may also set transaction indicator values for the call sessions that align with those assigned by the wireless device 100. The transaction identifiers may be used by the wireless device 100 and the mobile switching center 130 to transfer each of the call sessions over to the circuit switched domain.

Receipt of the multiple call session indicator may also cause the wireless device 100 to create or update a call control state machine for each call session to facilitate completion of the handover involving multiple call sessions in the circuit switched domain. The mobile switching center 130 may also create or update call control state machines for the respective call sessions, in response to the wireless device 100. Upon successful completion of the handover, the mobility management layer and the call control layer implemented by the wireless device 100 may enter an active state, and call establishment may be indicated to higher layers, for example, such that the establishment is displayed to the user.

Further, in response to receiving the multiple call session indicator, the wireless device 100 may indicate approval or acknowledgement of the multiple call session indicator by either remaining silent (e.g., a silent approval technique) or by providing a ‘connect acknowledge’ message indicating that the wireless device 100 has accepted the call. In an instance in which the wireless device 100 supports the use of the multiple call session indicator, the wireless device 100 may provide a ‘release complete’ message with an appropriate cause value if the wireless device does not accept a call. In an instance in which the wireless device 100 does not support the use of the multiple call session indicator or if another error occurs, the wireless device 100 may provide a ‘release complete’ message with a cause of “invalid transaction identifier value”.

Additionally or alternatively, upon completion of the handover, the wireless device 100 or a network entity of the packet switched domain may be configured to perform signaling to align the statuses of the transferred call sessions. To do so, for example, the wireless device 100 or the network entity of the packet switched domain may send a ‘status enquiry’ or ‘status’ message to the other. The ‘status enquiry’ or ‘status’ message may include information elements such as status values, linked transaction identifiers of the transferred call sessions, or the like. In this manner, according to some example embodiments, a reduction of signaling in the call control layer may be realized, because a single message or a message pair may carry the status information of all exiting calls.

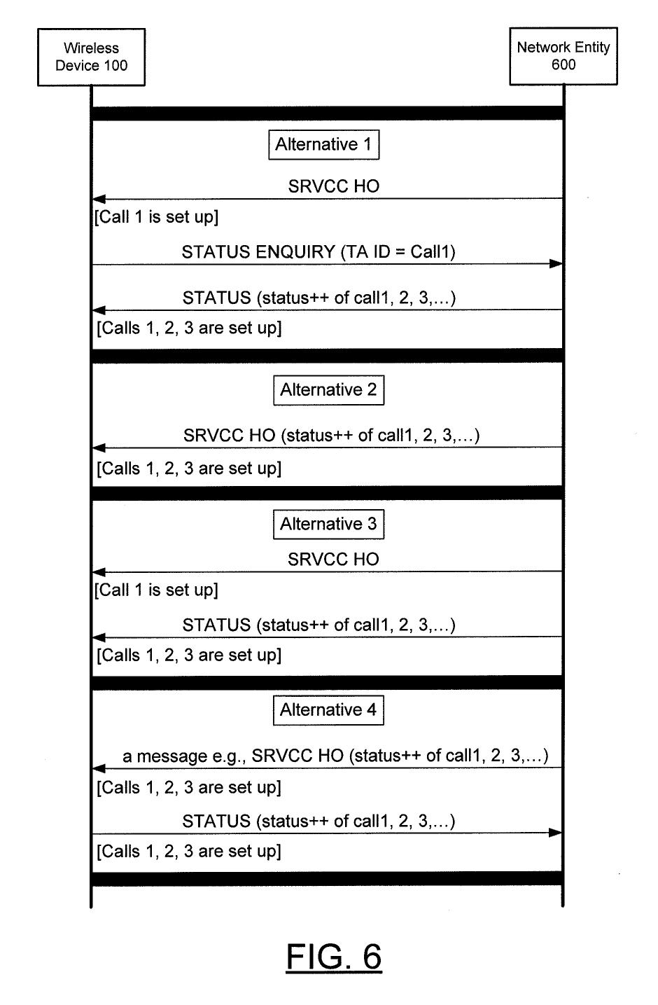

Referring now to FIG. 6, a number of alternative signaling schemes are provided for sending the multiple call session indicator to a wireless device 100 from a network entity 600. The network entity 600 may be, for example, the mobile switching center 130 of FIG. 1, or in some example embodiments, the network entity 600 may be the core network entity 110 of FIG. 1.

FIG. 6 includes four different example alternative signaling techniques for providing a multiple call session indicator to the wireless device 100. The four alternative signaling techniques are merely examples of some embodiments, and should not be construed as limiting the scope to these embodiments. It is contemplated that further alternatives based on subsets and combinations of aspects of these alternatives.

In the first alternative, the network entity 600 initially sends an SRVCC handover message to the wireless device 100. As a result of this handover message, the wireless device 100 configures (e.g., creates or updates) a call control state machine for a first call, which may be an active call. In response to the handover message, the wireless device may send, for example, a status enquiry message to the network entity 600. The status enquiry message may include a transaction identifier for, for example, the first call. In response to the status enquiry message, the network entity 600 may be configured to provide a status message to the wireless device 100 that includes a multiple call session indicator indicating, for example, a number of call sessions. In response to receipt of the status message with the multiple call session indicator, the wireless device 100 may be configured to create or update call control state machines for each of the multiple call sessions.

In the second alternative signaling technique, the network entity 600 may simply provide the multiple call session indicator to the wireless device 100 in the handover message (e.g., the SRVCC handover message). The network entity may, according to some example embodiments, provide the handover message with the multiple call session indictors without having been triggered to do so by the wireless device 100. In response to receipt of the handover message with the multiple call session indicator, the wireless device 100 may be configured to create or update call control state machines for each of the multiple call sessions.

In the third alternative, the network entity 600 initially sends an SRVCC handover message to the wireless device 100. As a result of this handover message, the wireless device 100 configures (e.g., creates or updates) a call control state machine for a first call, which may be an active call. The network entity 600 may be configured to then provide a status message to the wireless device 100 that includes a multiple call session indicator indicating, for example, a number of call sessions. The network entity may, according to some example embodiments, provide the status message with the multiple call session indictors without having been triggered to do so by the wireless device 100. In response to receipt of the status message with the multiple call session indicator, the wireless device 100 may be configured to create or update call control state machines for each of the multiple call sessions.

In the fourth alternative, the network entity 600 initially sends some type of message, such as, for example, an SRVCC handover message to the wireless device 100. The message provided to the wireless device may include the multiple call session indicator. As a result of this message, the wireless device 100 may configure (e.g., create or update) a call control state machine for each of the multiple call sessions. In response to the handover message, the wireless device may send a status message to the network entity 600. The status message may also include the multiple call session indicator, and the wireless device 100 may maintain or reconfigure the call control state machines for each of the sessions that are present.

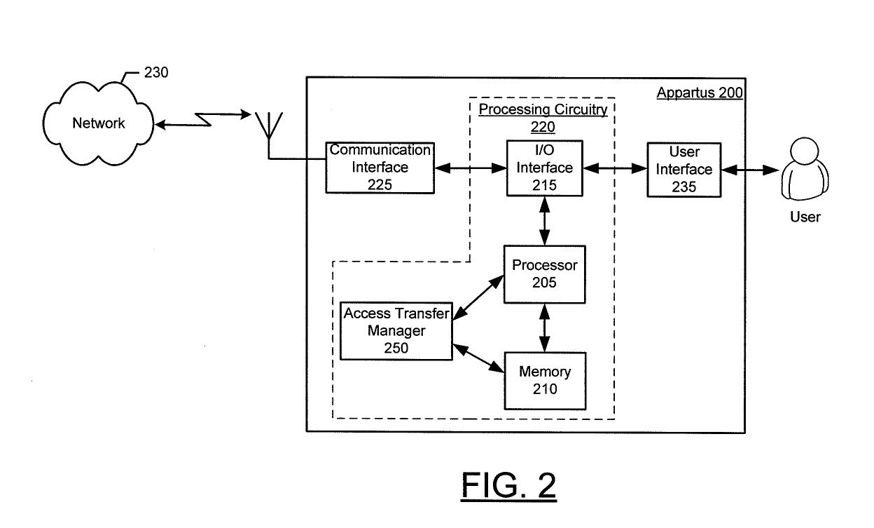

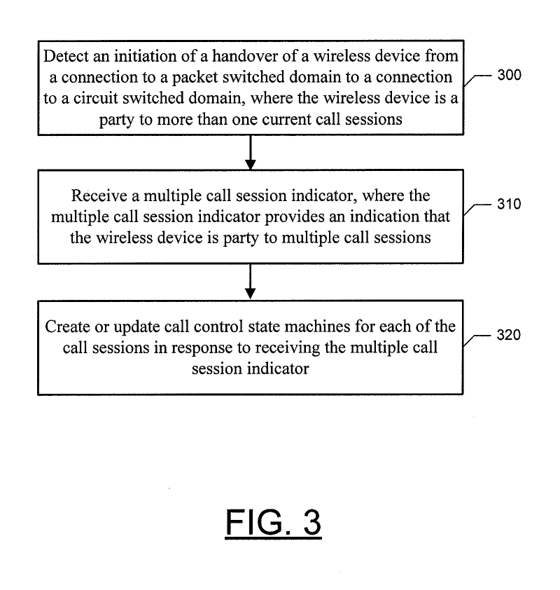

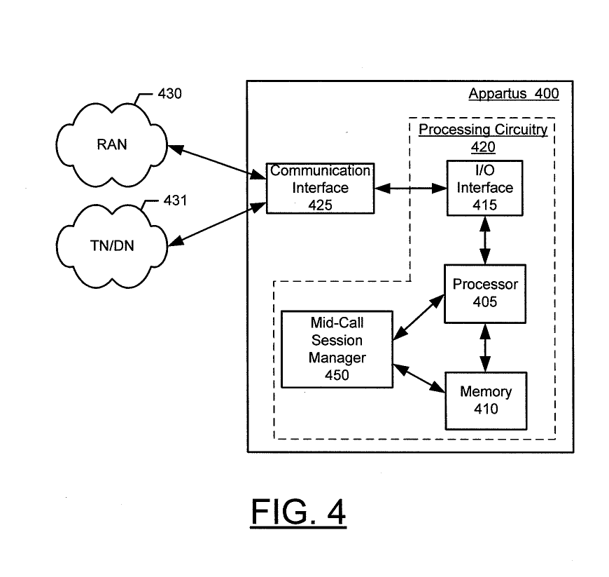

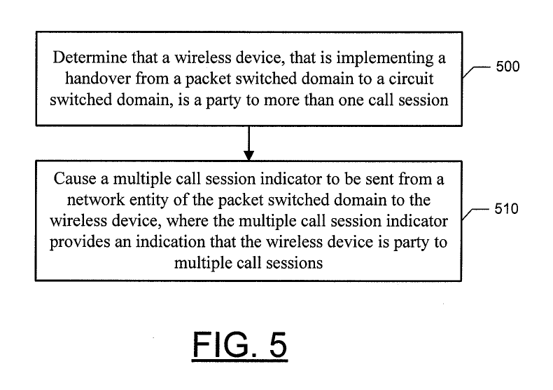

Having described at least some of the example embodiments in a system context, FIGS. 2 and 4 depict example apparatuses that may be configured to perform various functionalities as described herein, including those described with respect to operations described above and with respect to the flowcharts of FIGS. 3 and 5. FIG. 2 illustrates an apparatus configured to operate in accordance with functionality of wireless device 100 described above. FIG. 3 provides an example flowchart of some of the functionality performed by the wireless device 100. FIG. 4 illustrates an apparatus configured to operate in accordance with functionality of a network entity (e.g., the mobile switching center 130 or the core network entity 110). FIG. 5 provides an example flowchart of some of the functionality performed by the network entity that provides the multiple call session indicator to the wireless device.

Referring now to FIG. 2, an example embodiment is depicted as apparatus 200, which may be embodied as a wireless communications device or a portion thereof. As a wireless device, the apparatus 200 may be a mobile or stationary. In this regard, the apparatus 200 may embody or be a component of a server, computer, access point, handheld device (e.g., telephone, smartphone, tablet, digital book reader, portable digital assistant (PDA), gaming device, video/audio recorder, video/audio player, a global positioning system (GPS) device), any combination of the aforementioned, or the like.

The example apparatus 200 may include a processor 205, a memory 210, an Input/Output (I/O) interface 215, a communications interface 225, a user interface 235, and an access transfer manager 250. The processor 205 and the access transfer manager 250 may be collectively referred to as processing circuitry 220. In some example embodiments, the memory 210 and/or the I/O interface 215 may also be included in the processing circuitry 220, as depicted in FIG. 2.

The processor 205 may, according to some example embodiments, be embodied as various means for implementing the functionalities described herein, including those described with respect to the apparatus 200. The processor 205 may be embodied in a number of forms. For example, the processor 205 may be a microprocessor, a coprocessor, a controller, a special-purpose integrated circuit such as, for example, an ASIC (application specific integrated circuit), an FPGA (field programmable gate array), multiples and combinations thereof, or the like. In another example, the processor 205 may include one or more core processing devices that operate in concert. As such, the processor 205 may be a hardware device that may be comprised of a plurality of transistors, logic gates, a clock (e.g., oscillator), other circuitry, and the like to facilitate performance of the functionalities described herein. In some example embodiments, the processor 205 may be specifically configured through the execution of instructions or program code stored in a memory device such as memory 210 to perform specific functionality as described herein. In some example embodiments, the processor 205 may be completely or partially hardcoded to perform specific functionality as described herein. As such, through its specific structural configuration, the processor 205 may perform, and embody a means for performing, the various example methods, algorithms, and operations described herein.

The memory 210 may any type of hardware device that operates to store data and provide the stored data upon request. The data stored within the memory 210 may be instructions or program code that may be executed by the processor 205 to specially configure the processor 205. As such, in conjunction with the processor 205, the memory 210 may be a structural part of a means for performing various functionalities described herein. The memory 210 may be a tangible and/or non-transitory computer-readable storage medium. Memory 210 may be a volatile memory device (e.g., volatile random access memory, cache, or the like) and/or a non-volatile memory device (e.g., solid state memory, magnetic or optical storage devices, or the like). In some example embodiments, the memory 210 may be in communication with the processor 205 and/or other components via a shared bus.

The I/O interface 215 may be any device or circuitry configured to interface the processor 205 with other circuitry or devices, such as the communications interface 225 and the user interface 235. In some example embodiments, the I/O interface may embody or be in communication with a bus that is shared by multiple components within the processing circuitry 220 or the apparatus 200. In some example embodiments, the processor 205 may interface with the memory 210 via the I/O interface 215. The I/O interface 215 may be configured to convert signals (e.g., digital or analog signals) and data into a form that may be interpreted by the processor 205. The I/O interface 215 may also perform buffering of inputs and outputs to support the operation of the processor 205. According to some example embodiments, the processor 205 and the I/O interface 215 may be combined onto a single package, chip, or integrated circuit configured to perform, or cause the apparatus 200 to perform, various functionalities.

In some embodiments, the components that make up the processing circuitry 220 may embody or be a part of a chip or a chip set. In other words, the processing circuitry 220 may comprise one or more physical packages (e.g., chips, boards, or the like). In some example embodiments, other components and functionality may be included in the same physical package. For example, in some example embodiments, the circuitry supporting the communications interface and/or the circuitry supporting the user interface may be disposed together with the processing circuitry on a single chip to generate a “system on a chip” embodiment. As such, in some cases, a chip or chipset may constitute means for performing the functionalities described herein.

The communication interface 225 may be any component device configured to facilitate the receiving and/or transmitting of data from/to a network 230, which may be any type of wireless network including, but not limited to, a cellular network, a Wifi network, or the like. The communications interface may be configured to communicate information via any type of wired or wireless connection, and via any type of communications protocol that the communications interface 225 may be configured to support. Further, the communications interface 225 may be configured to support device-to-device communications for implementation when, for example, the apparatus 200 is a member of a mobile ad hoc network. Processor 205 may also be configured to facilitate communications via the communications interface 225 by, for example, controlling hardware included within the communications interface 225 (e.g., the antenna). In this regard, the communication interface 225 may include, for example, communications driver circuitry (e.g., circuitry that supports wired or wireless communications), one or more antennas, a transmitter, a receiver, a transceiver and/or supporting hardware, including, for example, a processor for enabling communications. Via the communication interface 225, the example apparatus 200 may communicate with various other network entities in a device-to-device fashion and/or via indirect communications through a base station, access point, server, gateway, router, or the like.

The user interface 235 may include any hardware configured to provide output to, or receive input from, a user. In this regard, the user interface 235 may include, for example, a keyboard, a mouse, a joystick, microphone (e.g., for using voice commands), a display (e.g., a touch screen display), a speaker, camera, accelerometer, vibrating motor (e.g., to provide haptic feedback), or other input/output mechanisms. Further, the processor 205 may comprise, or be in communication with, user interface circuitry configured to control the user interface components. In some example embodiments, the user interface 235 may have a dedicated processor and the processing circuitry 220 may interface with the dedicated user interface processor to control the user interface components. In some example embodiments, the processor 205 may use the I/O interface 215 to output signals that control the user interface 235.

The access transfer manager 250 of example apparatus 200 may be embodied in the configuration of the processor 205, either through the static configuration of the processor 205 (e.g., as an ASIC, FPGA, or the like) or through the execution of instructions stored in the memory 210. As such, via the access transfer manager 250, the processor 205 and the processing circuitry 220 may be configured to carry out the functions described herein, to thereby direct the operation of the apparatus 200. According to some example embodiments, the access transfer manager 250 may be wholly embodied in the processor 250, or some of the functionality of access transfer manager 250 may be embodied in other components of the apparatus 200 or a larger system. Further, the access transfer manager 250 may configure the processing circuitry 220 and the apparatus 200 to perform the functionalities described above with respect to the operation of wireless device 100.

Via the access transfer manager 250, the processing circuitry 220 may be configured to perform the operations provided in, for example, the flowchart of FIG. 3 to facilitate the operation of the apparatus 200. In this regard, at 300, the processing circuitry 220 may be configured to detect an initiation of a handover of a wireless device (e.g., the apparatus 200) from a connection to a packet switched domain (e.g., packet switching domain 105) to a connection to a circuit switched domain (e.g., circuit switched domain 140). Detection of the initiation of the handover may comprise receiving a handover message from a network entity (e.g., core network entity 110, mobile switching center 130, or the like). The handover may be implemented as part of single-radio voice call continuity handover from the packet switched domain to the circuit switched domain. Additionally or alternatively, the handover may involve the transfer of multiple call sessions that the wireless device is currently participating in. In this regard, the wireless device may be a party to more than one call session including at least a first call session and a second call session. For example, one of the call sessions may be an active talking call session, while the other may be currently held in an “on hold” state by the apparatus 200 or by a network entity of the packet switched domain. Alternatively, the call session may be included in a conference call that permits more than two parties to communicate in an aggregated session.

At 310, the processing circuitry may be configured, via the access transfer manager 250, to receive, from a network entity (e.g., mobile switching center 130, core network entity 110, or the like), a multiple call session indicator. The multiple call session indicator may provide an indication that the wireless device is party to multiple call sessions. The multiple call session indicator may be received, for example, as part of a call control protocol message, a radio control message, or a single-radio voice call continuity handover message. The processing circuitry 220 may receive the multiple call session indicator from the network entity without having signaled the network entity to provide data including the multiple call session indicator. However, in some example embodiments, the processing circuitry 220 may be configured to trigger the network entity (e.g., mobile switching center 130, core network entity 110, or the like) to send the multiple call session indicator by causing a message to be sent from the wireless device to the network entity. In some example embodiments, the message that is sent to trigger the response with the multiple call session indicator may be a ‘status enquiry’ sent from the wireless device to the network entity. The message sent form the wireless device to the network entity may include a transaction identifier for one or more of the call sessions. Additionally, according to some example embodiments, the processing circuitry 220 may be configured to create or update call control state machines at 320 for each of the call sessions in response to receiving the multiple call session indicator.

Referring now to FIG. 4, an example embodiment is depicted as apparatus 400, which may be embodied as a communications device within a wired or wireless network or a portion thereof. As a communications device, the apparatus 400 may be mobile or stationary. In this regard, the apparatus 400 may embody or be a component of a server, computer, access point, handheld device (e.g., telephone, smartphone, tablet, or the like), any combination of the aforementioned, or the like.

The example apparatus 400 may include a processor 405, a memory 410, an Input/Output (I/O) interface 415, a communications interface 425, and a mid-call session manager 450. The processor 405 and the mid-call session manager 450 may be collectively referred to as processing circuitry 420. In some example embodiments, the memory 410 and/or I/O interface 415 may also be included in the processing circuitry 420, as depicted in FIG. 4.

The processor 405 may, according to some example embodiments, be embodied as various means for implementing the functionalities described herein, including those described with respect to the apparatus 400. The processor 405 may be embodied in a number of forms. For example, the processor 405 may be a microprocessor, a coprocessor, a controller, a special-purpose integrated circuit such as, for example, an ASIC (application specific integrated circuit), an FPGA (field programmable gate array), multiples and combinations thereof, or the like. In another example, the processor 405 may include one or more core processing devices that operate in concert. As such, the processor 405 may be a hardware device that may be comprised of a plurality of transistors, logic gates, a clock (e.g., oscillator), other circuitry, and the like to facilitate performance of the functionalities described herein. In some example embodiments, the processor 405 may be specifically configured through the execution of instructions or program code stored in a memory device such as memory 410 to perform specific functionality as described herein. In some example embodiments, the processor 405 may be completely or partially hardcoded to perform specific functionality as described herein. As such, through its specific structural configuration, the processor 405 may perform, and embody a means for performing, the various example methods, algorithms, and operations described herein.

The memory 410 may any type of hardware device that operates to store data and provide the stored data upon request. The data stored within the memory 410 may be instructions or program code that may be executed by the processor 405 to specially configure the processor 405. As such, in conjunction with the processor 405, the memory 410 may be a structural part of a means for performing various functionalities described herein. The memory 410 may be a tangible and/or non-transitory computer-readable storage medium. Memory 410 may be a volatile memory device (e.g., volatile random access memory, cache, or the like) and/or non-volatile memory device (e.g., solid-state, magnetic or optical storage device, or the like). In some example embodiments, the memory 410 may be in communication with the processor 405 and/or other components via a shared bus.

The I/O interface 415 may be any device or circuitry configured to interface the processor 405 with other circuitry or devices, such as the communications interface 425. In some example embodiments, the I/O interface may embody or be in communication with a bus that is shared by multiple components within the processing circuitry 420 or the apparatus 400. In some example embodiments, the processor 405 may interface with the memory 410 via the I/O interface 415. The I/O interface 415 may be configured to convert signals (e.g., digital or analog signals) and data into a form that may be interpreted by the processor 405. The I/O interface 415 may also perform buffering of inputs and outputs to support the operation of the processor 405. According to some example embodiments, the processor 405 and the I/O interface 415 may be combined onto a single package, chip, or integrated circuit configured to perform, or cause the apparatus 400 to perform, various functionalities.

In some embodiments, the components that make up the processing circuitry 420 may embody or be a part of a chip or a chip set. In other words, the processing circuitry 420 may comprise one or more physical packages (e.g., chips, boards, or the like). In some example embodiments, other components and functionality may be included in the same physical package. For example, in some example embodiments, the circuitry supporting the communications interface and/or the circuitry supporting the user interface may be disposed together with the processing circuitry on a single chip to generate a “system on a chip” embodiment. As such, in some cases, a chip or chipset may constitute means for performing the functionalities described herein.

The communication interface 425 may be any component device configured to facilitate the receiving and/or transmitting of data from/to a network, which may be any type of wireless or wired network. In FIG. 4, the communications interface 430 is depicted as communicating with a radio access network (RAN) 430 of a communications system and/or a telephony network/data network (TD/DN) 431. The communications interface may be configured to communicate information via any type of wired or wireless connection, and via any type of communications protocol that the communications interface 425 may be configured to support. Further, the communications interface 425 may be configured to support device-to-device communications for implementation when, for example, the apparatus 400 is a member of a mobile ad hoc network. Processor 405 may also be configured to facilitate communications via the communications interface 425 by, for example, controlling hardware included within the communications interface 425. In this regard, the communication interface 425 may include, for example, communications driver circuitry (e.g., circuitry that supports wired or wireless communications), a transmitter, a receiver, a transceiver and/or supporting hardware, including, for example, a processor for enabling communications. Via the communication interface 425, the example apparatus 400 may communicate with various other network entities in a device-to-device fashion and/or via indirect communications through a base station, access point, server, gateway, router, or the like.

The mid-call session manager 450 of example apparatus 400 may be embodied in the configuration of the processor 405, either through the static configuration of the processor 405 (e.g., as an ASIC, FPGA, or the like) or through the execution of instructions stored in the memory 410. As such, via the mid-call session manager 450, the processor 405 and the processing circuitry 420 may be configured to carry out the functions described herein, to thereby direct the operation of the apparatus 400. According to some example embodiments, the mid-call session manager 450 may be wholly embodied in the processor 450, or some of the functionality of mid-call session manager 450 may be embodied in other components of the apparatus 400 or a larger system. Further, the mid-call session manager 450 may configure the processing circuitry 420 and the apparatus 400 to perform the functionalities described above with respect to the operation of the mobile switching center 103 or core network entity 110.

Via the mid-call session manager 450, the processing circuitry 420 may be configured perform the operations provided in, for example, the flowchart of FIG. 5 to facilitate the operation of the apparatus 400. In this regard, at 500, the processing circuitry 420 may be configured to determine that a wireless device (e.g., the wireless device 100), that is implementing a handover from a packet switched domain to a circuit switched domain, is party to more than one call session including at least a first call session and a second call session. For example, one of the call sessions may be an active talking call session, while the other may be currently held in an “on hold” state by the apparatus 400 or by a network entity. Alternatively, the call session may be included in a conference call that permits more than two parties to communicate in an aggregated session. In some example embodiments, the processing circuitry 420 may be configured to cause the multiple call session indicator be sent to inform the wireless device of the more than one call session when implementing a handover of the wireless device from the packet switched domain to a circuit switched domain. At 510, the processing circuitry 420 may be configured, via the mid-call session manager 450, to cause a multiple call session indicator to be sent from a network entity (e.g., apparatus 400). The multiple call session indicator may be sent from the apparatus 400 to the wireless device, or multiple call session indicator may be sent from the apparatus 400 to an MSC, which may transmit the indicator to the wireless device. The multiple call session indicator may provide an indication that the wireless device is party to multiple call sessions. The multiple call session indicator may be provided as part of a call control protocol message, a radio control message, or a single-radio voice call continuity handover message. The processing circuitry 420 may provide the multiple call session indicator without having received a request or other signal from the wireless device indicating that the multiple call session indicator should be provided. However, in some example embodiments, the processing circuitry 420 may be configured to provide the multiple call session indicator in response to a message from the wireless device to the network entity. In some example embodiments, the message that is received to trigger the response with the multiple call session indicator, may be a ‘status enquiry’ from the wireless device to the network entity.

FIGS. 3 and 5 illustrate flowcharts describing the operations of example systems, methods, and/or computer program products (e.g., program code stored on a non-transitory computer readable medium) according to example embodiments. It will be understood that each operation of the flowcharts, and/or combinations of operations in the flowcharts, can be implemented by various means as described above and otherwise herein. Means for implementing the operations of the flowcharts, combinations of the operations in the flowchart, or other functionality of example embodiments described herein may include the processing circuitry 220 or processing circuitry 420 in their various forms as described above. In this regard, for example, program code instructions for performing the operations and functions of apparatus 200 or apparatus 400 and otherwise described herein may be stored on a memory, such as memory 210 or memory 410 and may be executed by a processor, such as the processor 205 or the processor 405. As will be appreciated, any such program code instructions may be loaded onto a computer or other programmable apparatus (e.g., processor 205, processor 405, or the like) from a computer-readable medium to produce a particular machine, such that the particular machine becomes a means for implementing the functions specified in the flowcharts' operations. These program code instructions may direct a processor or other programmable apparatus to function in a particular manner to thereby generate a particular machine or particular article of manufacture. Further, the instructions stored in the memory may produce an article of manufacture, where the article of manufacture becomes a means for implementing the functions specified in the flowcharts' operations. Retrieval, loading, and execution of the program code instructions may be performed sequentially such that one instruction is retrieved, loaded, and executed at a time. However, in some example embodiments, retrieval, loading and/or execution may be performed, partially or wholly, in parallel such that multiple instructions are retrieved, loaded, and/or executed together. Additionally, it is understood that one or more operations of the flowcharts, and combinations of operations in the flowcharts, may be implemented by special purpose hardware-based computer systems and/or processors which perform the specified functions, or combinations thereof via special purpose hardware.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific ones disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
detecting, by processing circuitry, an initiation of a handover of a wireless device from a connection to a packet switched domain to a connection to a circuit switched domain, wherein the wireless device is a party to more than one call session including a first call session and a second call session;
receiving a multiple call session indicator, wherein the multiple call session indicator provides an indication that the wireless device is party to multiple call sessions; and
in response to receiving the multiple call session indicator, creating or updating call control state machines for each of the call sessions.

2. The method of claim 1, wherein detecting the initiation of the handover includes causing the handover to be implemented as a single-radio voice call continuity handover from the packet switched domain to the circuit switched domain.

3. The method of claim 1, further comprising triggering a network entity to send to the multiple call session indicator by causing a message to be sent from the wireless device to the network entity.

4. The method of claim 3, wherein triggering the sending of the multiple call session indicator includes causing a status enquiry to be sent from the wireless device to the network entity.

5. The method of claim 3, wherein triggering the sending of the multiple call session indicator includes causing the message to be sent with a transaction identifier for the first call session.

6. The method of claim 1, wherein receiving the multiple call session indicator includes receiving the multiple call session indicator as part of a call control message, a radio control message, or a single radio voice call continuity handover message.

7. An apparatus comprising processing circuitry configured at least to:
detect an initiation of a handover of a wireless device from a connection to a packet switched domain to a connection to a circuit switched domain, wherein the wireless device is a party to more than one call session including a first call session and a second call session;
receive a multiple call session indicator, wherein the multiple call session indicator provides an indication that the wireless device is party to multiple call sessions; and
in response to receiving the multiple call session indicator, create or update call control state machines for each of the call sessions.

8. The apparatus of claim 7, wherein the processing circuitry configured to detect the initiation of the handover includes being configured to cause the handover to be implemented as a single-radio voice call continuity handover from the packet switched domain to the circuit switched domain.

9. The apparatus of claim 7, wherein the processing circuitry is further configured to trigger a network entity to send to the multiple call session indicator by causing a message to be sent from the wireless device to the network entity.

10. The apparatus of claim 9, wherein the processing circuitry configured to trigger the sending of the multiple call session indicator includes being configured to cause a status enquiry to be sent from the wireless device to the network entity.

11. The apparatus of claim 9, wherein the processing circuitry configured to trigger the sending of the multiple call session indicator includes being configured to cause the message to be sent with a transaction identifier for the first call session.

12. The apparatus of claim 7, wherein the processing circuitry configured to receive the multiple call session indicator includes being configured to receive the multiple call session indicator as part of a call control message, a radio control message, or a single radio voice call continuity handover message.

13. A non-transitory computer readable medium having program code stored thereon, the program code, when executed, configures processing circuitry at least to:
detect an initiation of a handover of a wireless device from a connection to a packet switched domain to a connection to a circuit switched domain, wherein the wireless device is a party to more than one call session including a first call session and a second call session;
receive a multiple call session indicator, wherein the multiple call session indicator provides an indication that the wireless device is party to multiple call sessions; and
in response to receiving the multiple call session indicator, create or update call control state machines for each of the call sessions.

14. The computer readable medium of claim 13, wherein the program code that configures the processing circuitry to detect the initiation of the handover also configures the processing circuitry to cause the handover to be implemented as a single-radio voice call continuity handover from the packet switched domain to the circuit switched domain.

15. The computer readable medium of claim 13, wherein the program code further configures the processing circuitry to trigger a network entity to send to the multiple call session indicator by causing a message to be sent from the wireless device to the network entity.

16. The computer readable medium of claim 15, wherein the program code that configures the processing circuitry to trigger the sending of the multiple call session indicator also configures the processing circuitry to cause a status enquiry to be sent from the wireless device to the network entity.

17. The computer readable medium of claim 15, wherein the program code that configures the processing circuitry to trigger the sending of the multiple call session indicator also configures the processing circuitry to cause the message to be sent with a transaction identifier for the first call session.

18. The computer readable medium of claim 13, wherein the program code that configures the processing circuitry to receive the multiple call session indicator also configures the processing circuitry to perform receiving the multiple call session indicator as part of a call control message, a radio control message, or a single radio voice call continuity handover message.

19. A method comprising:
determining, by processing circuitry, that a wireless device, that is implementing a handover from a packet switched domain to a circuit switched domain, is a party to more than one call session including a first call session and a second call session; and
causing a multiple call session indicator to be sent from a network entity to the wireless device, wherein the multiple call session indicator provides an indication that the wireless device is party to multiple call sessions.

20. The method of claim 19, wherein causing the multiple call session indicator to be sent includes causing the multiple call session indicator be sent to inform the wireless device of the more than one call session prior to implementing the handover of the wireless device from the packet switched domain to a circuit switched domain.

21. The method of claim 19, further comprising receiving a message from the wireless device, and in response to receiving the message, causing the multiple call session indicator to be sent.

22. The method of claim 21, wherein causing the multiple call session indicator to be sent includes causing the multiple call session indicator to be sent as part of a call control message, a radio control message, or a single radio voice call continuity handover message.

23. An apparatus comprising processing circuitry configured at least to:
determine that a wireless device, that is implementing a handover from a packet switched domain to a circuit switched domain, is a party to more than one call session including a first call session and a second call session; and
cause a multiple call session indicator to be sent from a network entity to the wireless device, wherein the multiple call session indicator provides an indication that the wireless device is party to multiple call sessions.

24. The apparatus of claim 23, wherein the processing circuitry configured to cause the multiple call session indicator to be sent includes being configured to cause the multiple call session indicator be sent to inform the wireless device of the more than one call session prior to implementing the handover of the wireless device from the packet switched domain to a circuit switched domain.

25. The apparatus of claim 23, wherein the processing circuitry is further configured to receive a message from the wireless device, and in response to receiving the message, cause the multiple call session indicator to be sent.

26. The apparatus of claim 25, wherein the processing circuitry configured to cause the multiple call session indicator to be sent includes being configured to cause the multiple call session indicator to be sent as part of a call control message, a radio control message, or a single radio voice call continuity handover message.

27. A non-transitory computer readable medium having program code stored thereon, the program code, when executed, configures processing circuitry at least to:
determine that a wireless device, that is implementing a handover from a packet switched domain to a circuit switched domain, is a party to more than one call session including a first call session and a second call session; and
cause a multiple call session indicator to be sent from a network entity to the wireless device, wherein the multiple call session indicator provides an indication that the wireless device is party to multiple call sessions.

28. The computer readable medium of claim 27, wherein the program code that configures the processing circuitry to cause the multiple call session indicator to be sent also configures the processing circuitry to cause the multiple call session indicator be sent to inform the wireless device of the more than one call session prior to implementing the handover of the wireless device from the packet switched domain to a circuit switched domain.

29. The computer readable medium of claim 27, wherein the program code further configures the processing circuitry to receive a message from the wireless device, and in response to receiving the message, cause the multiple call session indicator to be sent.

30. The computer readable medium of claim 29, wherein the program code that configures the processing circuitry to cause the multiple call session indicator to be sent also configures the processing circuitry to cause the multiple call session indicator to be sent as part of a call control message, a radio control message, or a single radio voice call continuity handover message.
